(19) United States
(12) Patent Application Publication
(10) Pub. No.: US 2014/0093643 A1
(43) Pub. Date: Apr. 3, 2014

(54) METHOD AND SYSTEM OF DEPOSITING A VISCOUS MATERIAL INTO A SURFACE CAVITY

(71) Applicant: TYCO ELECTRONICS SERVICES GMBH, Schaffhausen (CH)

(72) Inventor: Haiying Li, Elk Grove, CA (US)

(73) Assignee: TYCO ELECTRONICS SERVICES GMBH, Schaffhausen (CH)

(21) Appl. No.: 13/631,208

(22) Filed: Sep. 28, 2012

(51) Int. Cl. B05C 5/00

(52) U.S. Cl. 427/238; 118/50

(57) ABSTRACT

A method of depositing a viscous material into a surface cavity of a target object. The method includes providing the target object having the surface cavity. The target object has an exterior surface with a cavity opening that provides access to the surface cavity. The method also includes evacuating air from the surface cavity through the cavity opening and covering the cavity opening to seal the surface cavity. The surface cavity constitutes a partial vacuum when the surface cavity is sealed. The method also includes permitting a viscous material to flow into the surface cavity through the cavity opening as the cavity opening is uncovered.

### BACKGROUND

The subject matter herein relates generally to a method of depositing a viscous material into cavities that are located along a surface of an object.

During the manufacture of an object, it may be necessary to deposit a viscous material, such as an adhesive, into small cavities along a surface of the object. For instance, some electronic devices, such as transformers, inductors, baluns, couplers and filters, include a circuit board that has blind cavities along a surface of the circuit board. Blind cavities are cavities that do not extend entirely through the object. The blind cavities may be formed by drilling one or more layers that form the board substrate. In some cases, electrical functional components are then positioned in the blind cavities. By way of one specific example, a ferrite core may be deposited into a blind cavity of the board substrate. The blind cavity may then be filled with a resin that encapsulates the ferrite core. Conductive windings may be wrapped about the encapsulated ferrite core to form a transformer.

In some cases, as the viscous material flows into the blind cavities, air that is trapped in the blind cavities may form air bubbles in the viscous material. When the viscous material is cured, the air bubbles become voids in the electronic device. Such voids may negatively affect the quality performance, durability) of the electronic device. In addition to the above, the blind cavities may be improperly filled because chemical properties of the surfaces that define the blind cavities and/or the dimensions of the blind cavities may limit the flowability of the viscous material.

Current manufacturing methods may include depositing the viscous material into the blind cavities while the board substrate is located in an evacuated environment, such as a vacuum chamber. However, it may be necessary to remove materials or bring new materials into the chamber during the manufacturing process. When materials are brought into or removed from the chamber, the pressure level of the chamber typically changes. The manufacturing process may be halted to re-establish the evacuated state of the chamber. Such stoppages increase the duration of the manufacturing process.

Accordingly, there is a need for an improved method for effectively titling surface cavities of an object with a viscous material.

### BRIEF DESCRIPTION

In one embodiment, a method of depositing a viscous material into a surface cavity of a target object is provided. The method includes providing the target object having the surface cavity. The target object has an exterior surface with a cavity opening that provides access to the surface cavity. The method also includes evacuating air from the surface cavity through the cavity opening and covering the cavity opening to seal the surface cavity. The surface cavity constitutes a partial vacuum when the surface cavity is sealed. The method also includes permitting a viscous material to flow into the surface cavity through the cavity opening as the cavity opening is uncovered.

In another embodiment, a method of depositing a viscous material into a target object is provided. The method includes providing the target object. The target object includes first and second surface cavities. The method may also include evacuating air from the first and second surface cavities and sealing the first and second surface cavities. The surface cavities holding partial vacuums when sealed. The method may also include sequentially filling the first and second surface cavities with the viscous material such that the viscous material begins to flow into the second surface cavity after the first surface cavity is at least partially filled.

In another embodiment, a system is provided that includes a system housing having an engagement side configured to form an interface with an exterior surface of a target object. The exterior surface has a cavity opening that provides access to a surface cavity of the target object. The engagement side includes a gas inlet and a material outlet that are each configured be in fluid communication with the surface cavity at different times as the engagement side slides along the target object. The system also includes a vacuum device having a flow chamber that is in fluid communication with the gas inlet. The vacuum device generates a suction airflow through the gas inlet and into the flow chamber to evacuate the surface cavity. The engagement side covers the cavity opening after the surface cavity is evacuated such that a partial vacuum exists therein. The system also includes a filling device having a reservoir for holding a viscous material. The reservoir is in fluid communication with the material outlet. The viscous flows through the material outlet and into the surface cavity when the material outlet clears the cavity opening.

In one or more embodiments, the target object may include a plurality of the surface cavities with each having a corresponding cavity opening. Optionally, the viscous material may flow at least partially concurrently into the surface cavities. In some embodiments, the target object may be a planar electronic device such as, but not limited to, a transformer, inductor, balun, coupler, or filter. In certain embodiments, the surface cavity of the target object is a blind cavity.

### BRIEF DESCRIPTION OF THE DRAWINGS

FIG. 1 is a schematic view of a system for depositing a viscous material into a surface cavity in accordance with one embodiment.

FIG. 2 is a plan view of the surface cavity in accordance with one embodiment.

FIG. 3 is a flowchart that illustrates a method of depositing a viscous material into a surface cavity in accordance with one embodiment.

FIG. 4 is a cross-section of a target object as viscous material is deposited into a surface cavity of the target object in accordance with one embodiment.

FIG. 5 illustrates two surface cavities as an outlet clears the surface cavities in accordance with one embodiment.

FIG. 6 illustrates two surface cavities as two outlets clear the surface cavities in accordance with one embodiment.

FIG. 7 illustrates two surface cavities as multiple outlets clear each of the surface cavities in accordance with one embodiment.

FIG. 8 is a cross-section of a portion of an electronic device formed in accordance with one embodiment.

FIG. 9 is a perspective view of the electronic device formed in accordance with one embodiment.

### DETAILED DESCRIPTION

One or more embodiments described herein include methods and systems for depositing (e.g., filling) a viscous material into a surface cavity of a target object. In certain embodiments, the surface cavity is evacuated to provide a partial vacuum in the surface cavity that facilitates the flow of the viscous material into the surface cavity. As used herein, the terms “depositing” and “filling” include passively or actively providing viscous material to the surface cavities. For example, when a surface cavity is passively filled, the viscous material may flow into the surface cavity without substantial assistance from other forces other than gravity and a pressure difference that exists because of the partial vacuum. In some cases, the partial vacuum or, more specifically, the pressure difference, may enable the viscous material to flow against the force of gravity. When a surface cavity is actively filled, a pneumatic system may urge or drive a flow of the viscous material into the surface cavity. The partial vacuum may provide less resistance to the flow of the viscous material as compared to other embodiments in which a partial vacuum does not exist.

As used herein, the term “target object” is not intended to be limiting but includes various objects that have one or more surface cavities capable of receiving a viscous material during manufacture. When the viscous material is deposited, the target object may be at various stages of manufacture. In other words, the target object may not yet be a finished product that is ready to be used for the target object's intended purpose. The target object may be, for example, a planar board substrate that will be used to form a planar electronic device. The surface cavities may be configured to receive device components therein before or after the viscous material is added. Device components may include, for example, magnetic components (e.g., magnetic or ferrite cores) that are embedded into the corresponding board substrate. However, other components may be inserted into the surface cavities before or after the viscous material is added. In embodiments that utilize a board substrate, the board substrate may have a composition that is similar to a printed circuit board (PCB) and may include a plurality of substrate layers (e.g., FR-4).

In such embodiments that include device components, the device components can be encapsulated by the viscous material. The viscous material may be a low-stress adhesive, such as a low-stress epoxy, that is disposed to provide a proper electrical environment. In a cured state, the epoxy can be near solid, flexible, and/or elastic in nature. The elasticity and/or flexibility of the cured epoxy can vary depending on the curing agents used and/or the composition of the epoxy.

A surface cavity may also be described as a hole, recess, or channel. As used herein, a “blind cavity” includes a surface cavity of a target object that extends a designated depth from a cavity opening into the target object without extending entirely through the target object. Blind cavities have only a single cavity opening. When suction is applied to a blind cavity, gas molecules that are removed from the surface cavity through the cavity opening may not be replaced from another source that is in fluid communication with the surface cavity. By way of example, blind cavities in a board substrate may be formed by drilling from one side of a board substrate up to a designated depth that is less than a thickness of the board substrate.

However, a blind cavity is not required to be defined by a single component or part, such as the board substrate, or must be “blind” at all times. For example, a board substrate may be drilled entirely through to form a plurality of passages that extend through the board substrate. A plate may then be pressed against one side of the board substrate thereby covering openings to the passages and forming blind cavities. The blind cavities may then be filled as described herein. After the blind cavities are filled, the plate may be removed, such as after the viscous material has cured.

As used herein, a viscous material is any material that is capable of flowing into a surface cavity due to the pressure differences that are caused at least partially by the partial vacuums described herein. Viscous material may also be described as a material that is capable of sufficiently flowing into a surface cavity under commercially reasonable manufacturing conditions. A material may flow sufficiently if the material flows in a commercially reasonable amount of time. The viscous material may be a fluid that includes at least one of a liquid (e.g., aqueous solution, oil, and the like), a mixture (e.g., a slurry), or a gas. The viscous material may have a viscosity that is higher, about equal to, or lower than a viscosity of water.

However, it is understood that the flowability of a material may be based on a plurality of conditions or factors. For example, a material may sufficiently flow when the material is above a reasonable threshold temperature, but may not sufficiently flow when the material is below a designated temperature. Whether a material may sufficiently flow into a surface cavity may also be based on chemical properties of the viscous material or chemical properties of the surfaces that define the surface cavities. For example, the material or the surface that defines the cavity may be hydrophobic or hydrophilic, which may affect the flowability of the material. Moreover, whether a material sufficiently flows through a conduit (or outlet) may be determined by surface properties of the conduit or dimensions of the conduit.

In particular embodiments, the viscous material includes a resin that is configured to be cured after being deposited into the surface cavity. The resin may be cured in various manners, such as through heat, ultraviolet radiation, or by chemical additives. The resin may also be cured by allowing the target object to rest in an ambient environment for at least a designated period of time.

In addition, the surface cavities described herein may be localized cavities along the target object. For example, the surface cavities may have limited dimensions. For example, in some embodiments, a surface cavity may have a maximum height that is less than about 10 millimeters, a maximum width that is less than about 20 millimeters, and a maximum length that is less than about 20 millimeters. In more particular embodiments, a surface cavity may have a maximum height that is less than 3 millimeters, a maximum width that is less than 10 millimeters, and a maximum length that is less than 10 millimeters. In some cases, the dimensions of a surface cavity may be such that the flow of the viscous material would be impeded if not for the partial vacuums described herein.

The surface cavities described herein, including the blind cavities, may have various volumes. In some embodiments, the volume of a surface cavity may be less than about 1000 microliters or less than about 500 microliters. In particular embodiments, the volume is less than about 250 microliters or less than about 100 microliters. In more particular embodiments, the volume is less than about 50 microliters. For such embodiments that include a device component in the surface cavity, the volume of viscous material that is added to the surface cavity may be less than about 100 microliters or less than about 50 microliters. In certain embodiments, the viscous material added to the surface cavity is less than 20 microliters.

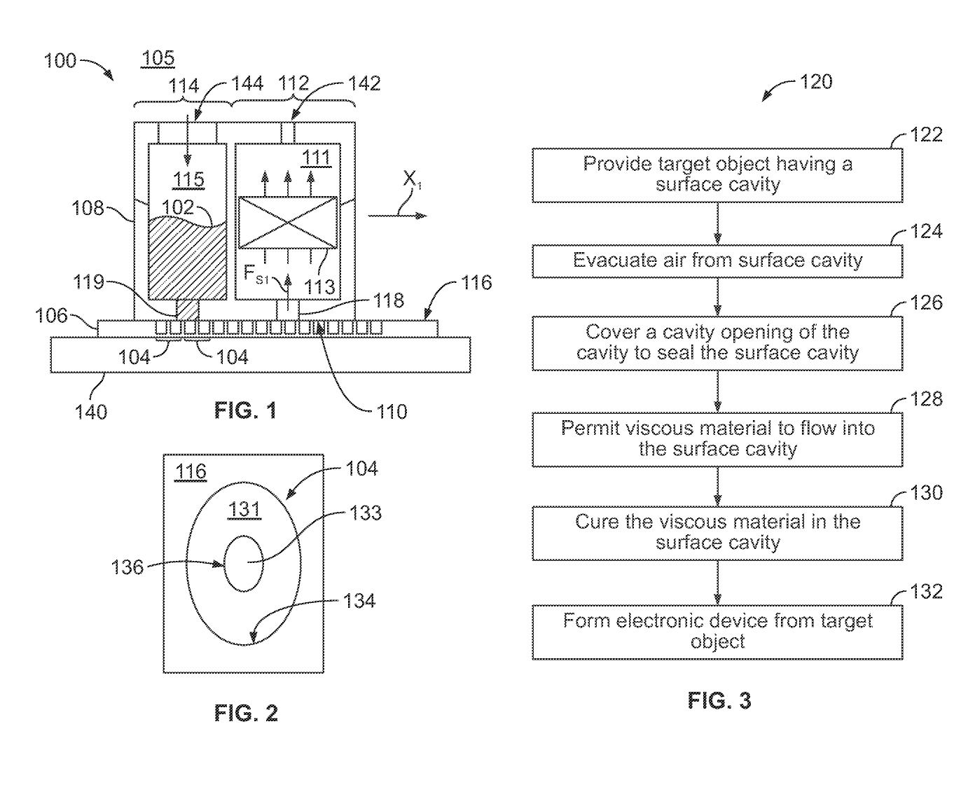

FIG. 1 is a schematic view of a cavity-filling system 100 for depositing a viscous material 102 into surface cavities 104 of a target object 106. The system 100 includes a system housing 108 having an engagement side 110 that is configured to slide along an exterior surface 116 of the target object 106. In the illustrated embodiment, the system housing 108 may move in a lateral or sliding direction as indicated by the arrow X₁ relative to the target object 106. As used herein, the terms “move,” “slide,” and the like refer to relative actions. As such, when the system housing 108 is described as moving or sliding along the target object 106, the system housing 108 may be: (a) moving while the target object 106 is stationary; (b) moving while the target object 106 is also moving; or (c) stationary while the target object is moving. Moreover, the system housing 108 and the target object 106 are not required to move relative to each other in a linear manner. For example, in some embodiments, the target object 106 may be disc-shaped. In such cases, the system housing 108 may move along a circular path that moves around a rotational center of the disc-shaped target object 106.

The system 100 also includes a vacuum device 112 having an airflow generator 113 (e.g., fan, blower, pump, and the like) and a filling device 114 having a reservoir 115 that includes the viscous material 102. The vacuum device 112 may include a flow chamber 111 having the airflow generator 113 disposed therein. As shown in FIG. 1, the engagement side 110 includes a gas inlet 118 and a material outlet 119. The gas inlet 118 and the material outlet 119 are configured to be in fluid communication with the surface cavities 104 at different times as the engagement side 110 slides along the exterior surface 116. Air is configured to flow through the gas inlet 118 into the flow chamber 111, and the viscous material 102 is configured to flow through the material outlet 119.

As will be described in greater detail below, the vacuum device 112 is configured to provide a suction airflow F_{S1} that evacuates the surface cavities 104 to form a partial vacuum in the surface cavities 104. The filling device 114 is configured to permit the viscous material 102 to flow through the material outlet 119 and into the surface cavities 104. The partial vacuum in the surface cavities 104 may facilitate the filling process by drawing the viscous material 102 into the surface cavities 104. It is understood that this drawing action may occur due to a pressure difference between the partial vacuum in the surface cavity 104 and a high-pressure volume 105 that is in fluid communication with the viscous material 102. For example, the viscous material 102 may be located in a fluidic manner between the surface cavity 104 and the high-pressure volume 105 (e.g., the ambient environment). When the viscous material 102 is permitted to flow into the surface cavity 104, the weight of the viscous material 102 and higher pressure gas (e.g., ambient air) in the high-pressure volume 105 may cause the viscous material to flow into the surface cavity 104. More specifically, the gas in the high-pressure volume 105 may flow into the reservoir 115 where the viscous material 102 is located as the viscous material 102 flows into the surface cavity 104.

Also shown in FIG. 1, the system 100 includes an object holder 140 that is configured to position (e.g., align) the target object 106 with respect to the engagement side 110. In the illustrated embodiment, the object holder 140 is a platform or stage and the target object 106 rests on the platform during the deposition or filling process. However, the object holder 140 may have other embodiments. For example, the object holder 140 may be similar to an assembly-line conveyor belt that moves the target object 106 in a predetermined manner. The object holder 140 may also be a mechanical arm or hand that grips the target object during the deposition process.

In the illustrated embodiment, the vacuum device 112 and the filling device 114 are part of the system housing 108. However, in alternative embodiments, the vacuum and filling devices 112, 114 may be separate devices that are positioned together such that the vacuum and filling devices form a system housing having an engagement side. As shown, the flow chamber 111 is in fluid communication with a port 142. The airflow generated by the vacuum device 112 exits the flow chamber 111 through the port 142.

Also shown, the filling device 114 includes a port 144 that is in fluid communication with the reservoir 115. In some embodiments, the viscous material 102 is held in the reservoir 115 before flowing into the surface cavity 104. During the deposition process, air may flow through the port 144 and into the reservoir 115 as the viscous material 102 exits the reservoir 115 and flows into the surface cavities 104.

In the illustrated embodiment, the reservoir 115, the flow chamber 111, and the airflow generator 113 are coupled to the system housing 108 and move with the engagement side 110. However, in other embodiments, at least one of the reservoir 115, the flow chamber 111, or the airflow generator 113 does not move with the engagement side 110. For example, the airflow generator 113 may be fluidly connected to the system housing 108 through, for example, a flexible hose. Likewise, the reservoir 115 may be fluidly connected to the system housing 108 through a flexible hose.

In particular embodiments, the target object 106 is a planar board substrate (e.g., a circuit board or a portion of a circuit board) that may have a plurality of stacked dielectric layers. However, the target object is not limited to being a board substrate. The target object may be any product, apparatus, and/or device that has a surface cavity and is capable of having viscous material deposited therein. For example, the target object may be electronic devices other than transformers, inductors, baluns, couplers, or filter. The target object may also be, for example, a multi-well plate that is used to conduct biological and/or chemical reactions. The plate may have an array of wells. In such an embodiment, the viscous material may be a buffer solution or a reagent solution that is added to each well.

FIG. 2 is a plan view of the exterior surface 116 and illustrates the surface cavity 104 in greater detail. In the illustrated embodiment, the surface cavity 104 includes a channel 131 that circumferentially extends around a dielectric member or post 133. The surface cavity 104 is defined by an inwardly-facing surface 134 of the target object 106 (FIG. 1) and an outwardly-facing surface 136 of the dielectric member 133. The target object 106 may be drilled (e.g., routed) or molded to provide the inwardly- and outwardly-facing surfaces 134, 136 and to form the channel 131. As shown in the plan view of FIG. 2, the surface cavity 104 may be oval-shaped. However, the surface cavity 104 may have different shapes in other embodiments. For example, the surface cavity 104 may be a short linear groove or a circular well. The surface cavity 104 may also be annular or ring-shaped. In some embodiments, the channel 131 does not define a dielectric member such that the surface cavity is a well.

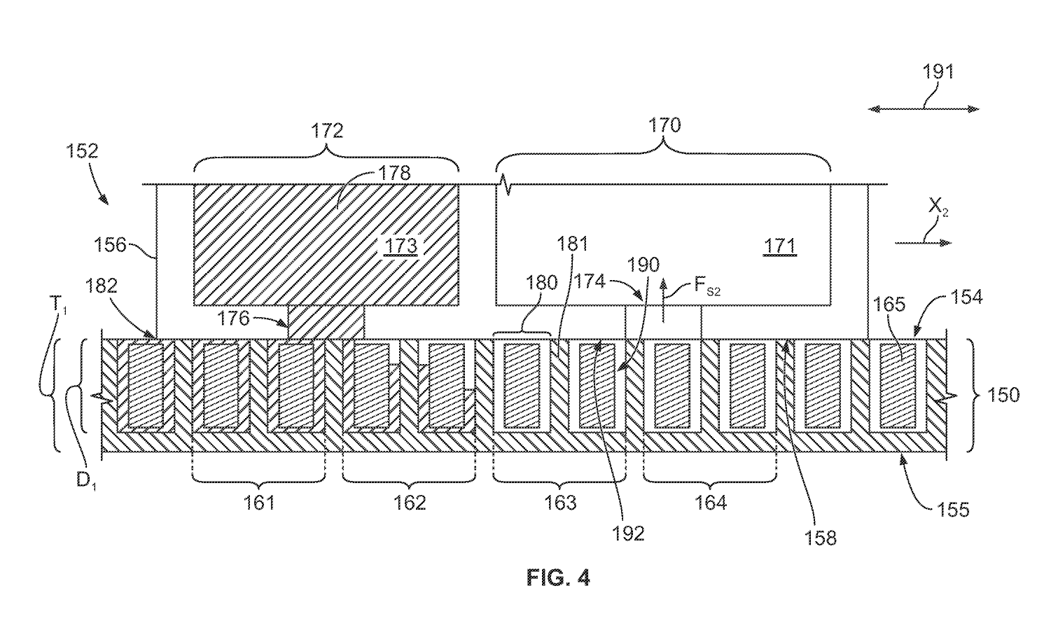

FIG. 3 is a flowchart that illustrates a method 120 of depositing a viscous material into a surface cavity. The method 120 is described with reference to FIG. 4, which shows a board substrate 150 and a portion of a cavity-filling system 152. As described above, the target object 106 (FIG. 1) may be a board substrate, such as the board substrate 150. The system 152 may be similar to the system 100 (FIG. 1). The board substrate 150 has first and second exterior surfaces 154, 155 that face in opposite directions and have a thickness T₁ that extends therebetween. The board substrate 150 includes a plurality of surface cavities 161-164 that extend from the exterior surface 154 into the thickness T₁ toward the exterior surface 155. In the illustrated embodiment, the surface cavities 161-164 are similar to the surface cavity 104 (FIG. 1). As such, for each of the surface cavities 161-164, the cross-section of the board substrate 150 in FIG. 4 reveals two portions of a single channel 190 that surrounds a dielectric member 181. Each of the surface cavities 161-164 has a cavity opening 180 that extends along the exterior surface 154 with the channel 190. As shown, the surface cavities 161-164 may be blind cavities having depths D₁ that are less than the thickness T₁.

The system 152 has a system housing 156 having an engagement side 158. The system 152 includes a vacuum device 170 having a flow chamber 171 and a filling device 172 having a reservoir 173. The engagement side 158 has a gas inlet 174 that is in fluid communication with the flow chamber 171, and a material outlet 176 that is in fluid communication with the reservoir 173. The gas inlet 174 may be a hole in the engagement side 158 that is located directly between the flow chamber 171 and the board substrate 150. The material outlet 176 may be a hole in the engagement side 158 that is located directly between the reservoir 173 and the board substrate 150. In other embodiments, however, one or more conduits (e.g., channels, tubes, pipes, and like) may fluidly connect the gas inlet 174 and the material outlet 176 to the respective flow chamber 171 and the reservoir 173.

The vacuum device 170 may include an airflow generator (not shown) that is configured to generate a suction airflow F_{S2} through the gas inlet 174 into the flow chamber 171. The material outlet 176 is configured to allow viscous material 178 to flow therethrough from the reservoir 173 to one or more of the surface cavities 161-164.

The method 120 may include providing at 122 the board substrate 150 having the surface cavities 161-164. In some embodiments, the board substrate 150 may already have the surface cavities 161-164 when the board substrate 150 is provided. In other embodiments, the method 120 may include forming the surface cavities 161-164 by drilling, etching, stamping, or punching the substrate material from the board substrate 150. In some embodiments, the surface cavities 161-164 may already include device components 165 therein when the board substrate 150 is provided at 122. In other embodiments, the method 120 may include loading the device components 165 into the surface cavities 161-164 before or after the viscous material is deposited. In the illustrated embodiment, the device component 165 is a magnetic core, although other components may be disposed in the surface cavities 161-164.

The providing operation 122 may include positioning the board substrate 150 adjacent to the engagement side 158 so that the exterior surface 154 abuts the engagement side 158. As shown in FIG. 4, the engagement side 158 is configured to relatively slide along the exterior surface 154 as indicated by the arrow X₂. The exterior surface 154 may be substantially planar as shown in FIG. 4 or, in an alternative embodiment, the exterior surface 154 may have a non-planar contour for at least portions of the exterior surface 154. In such embodiments, the engagement side 158 may have a complementary shape such that the engagement side 158 is slidable along the exterior surface 154.

During the deposition process, the exterior surface 154 and the engagement side 158 define an interface 182. The interface 182 may be a sealed interface such that fluid (e.g., air and/or liquid) is significantly impeded from leaking through the interface 182 to undesired locations. For example, at least one of the exterior surface 154 or the engagement side 158 may have surface properties that impede the flow of the viscous material 178. The exterior surface 154 or the engagement side 158 may be hydrophobic or hydrophilic. In addition, the system housing 108 may be forced against the board substrate 150 and/or an object holder (not shown) may force the board substrate 150 against the engagement side 158 to facilitate sealing the interface 182.

The method 120 may also include evacuating air at 124 from the surface cavity through the cavity opening. As used herein, the term “air” includes any suitable gas or combination of such gases. For example, in FIG. 4, air within the surface cavity 164 is being evacuated by the vacuum device 170. In particular, the air is being evacuated from the surface cavity 164 through the gas inlet 174 and into the flow chamber 171. From the flow chamber 171, the air may be vented or exhausted into an exterior environment through an exit port, such as the port 142 shown in FIG. 1. As the surface cavity 164 is evacuated, gas molecules from the air are removed from the surface cavity 164 without being replaced by other gas molecules. As such, a total number of gas molecules in the surface cavity 164 is reduced and, consequently, a gas pressure in the surface cavity 164 is also reduced. The gas pressure in the surface cavity 164 is lowered relative to the gas pressure before evacuation. When the gas pressure is lowered, the surface cavity 164 may be characterized as having or holding a partial vacuum. A degree to which a partial vacuum is formed may be based on a power of the airflow generator and/or strength of the sealed interface 182.

The method 120 may also include covering at 126 the cavity opening to seal the surface cavity. As illustrated in FIG. 4, the board substrate 150 and the engagement side 158 move relative to each other (e.g., slide alongside each other) during the deposition process. The vacuum device 170 may continue to evacuate the surface cavity 164 until the surface cavity 164 is no longer in fluid communication with the vacuum device 170. More specifically, as the board substrate 150 and the engagement side 158 move relative to each other, the engagement side 158 covers the cavity opening 180 such that the surface cavity 164 is sealed. When the cavity opening 180 is sealed, the surface cavity 164 may contain a partial vacuum, in FIG. 4, the surface cavity 163 is sealed by a wall portion 192 of the engagement side 158. The wall portion 192 extends between the gas inlet 174 and the material outlet 176 and is configured to slide over the surface cavities 161-164.

When the engagement side 158 covers the cavity opening of a surface cavity, such as the surface cavity 163, the engagement side 158 may effectively seal the surface cavity from external fluid sources such that the surface cavity remains partially evacuated as the engagement side 158 moves along the exterior surface 154. To this end, the interface 182 between the engagement side 158 and the exterior surface 154 may be configured to at least momentarily prevent loss of the partial vacuum due to fluid leakage (e.g., air and/or liquid) into the surface cavity 163. However, it is understood that some tolerances may allow at least some leakage into the surface cavity 163. Nonetheless, the surface cavity 163 holds a partial vacuum when the material outlet 176 clears the cavity opening 180.

The method 120 may also include permitting at 128 the viscous material to flow into a surface cavity through the corresponding cavity opening as the cavity opening is uncovered. In FIG. 4, the material outlet 176 has cleared the cavity opening 180 of the surface cavity 162. In other words, the material outlet 176 is in fluid communication with the surface cavity 162 through the cavity opening 180. When the cavity opening 180 is cleared, the relatively low gas pressure in the surface cavity 162 results in flow of the viscous material 178 into the surface cavity 162, thereby at least partially filling the surface cavity 162. When the viscous material 178 enters the surface cavity 162, any remaining gas molecules in the partial vacuum may move toward the cavity opening. In some cases, the gas molecules may form one or more bubbles that rise through the material outlet 176 or remain proximate to the cavity opening 180.

In some embodiments, the method 120 may include sequentially depositing the viscous material 178 into a series of surface cavities, such as the surface cavities 161-164. In such cases, the evacuating operation 124 may include sequentially evacuating surface cavities such that one surface cavity begins to be evacuated before an adjacent surface cavity. As shown in FIG. 4, the surface cavities 161-164 may be substantially aligned with each other along an axis 191 that extends parallel to the arrow X₂. As the vacuum device 170 slides along the exterior surface 154, the gas inlet 174 may be in fluid communication with one surface cavity before the gas inlet 174 is in fluid communication with an adjacent surface cavity. For example, with reference to FIG. 4, as the gas inlet 174 slides along the exterior surface 154 in a direction indicated by the arrow X₂, the gas inlet 174 will be in fluid communication with the surface cavity 161 first, the surface cavity 162 second, the surface cavity 163 third, and then the surface cavity 164 fourth. As the gas inlet 174 slides over each of the cavity openings 180, the gas in the surface cavities 161-164 is evacuated by the vacuum device 170. Accordingly, the surface cavities 161-164 are sequentially evacuated.

In some embodiments, the gas inlet 174 may be in fluid communication with adjacent surface cavities at least partially concurrently. For example, although the gas inlet 174 may be in fluid communication with the surface cavity 161 before the surface cavity 162, the gas inlet 174 may be in fluid communication with each of the surface cavities 161, 162 at least partially concurrently. Accordingly, in some embodiments, the cavity openings 180 of the surface cavities 161-164 may be dimensioned and located proximate to each other and the gas inlet 174 may be dimensioned relative to the surface cavities 161-164 such that the gas inlet 174 is in fluid communication with two surface cavities at once.

The covering operation 126 may also include covering the cavity openings 180 and sealing the corresponding surface cavities 161-164 according to a designated sequence or order. As the gas inlet 174 clears each of the cavity openings 180 such that the respective surface cavity is no longer in fluid communication with the gas inlet 174, the engagement side 158 may seal the corresponding cavity opening 180. In FIG. 4, the surface cavity 161 would be sealed before the surface cavity 162, which would be sealed before the surface cavity 163 and so forth.

Likewise, the permitting operation 128 may fill surface cavities according to a designated sequence or order. For example, as the filling device 172 slides along the exterior surface 154, the material outlet 176 may be in fluid communication with one surface cavity before the material outlet 176 is in fluid communication with an adjacent surface cavity. With respect to FIG. 4, as the material outlet 176 slides along the exterior surface 154, the material outlet 176 will be in fluid communication with the surface cavity 161 first, the surface cavity 162 second, the surface cavity 163 third, and the surface cavity 164 fourth. Thus, the permitting operation 128 may include sequentially filling adjacent surface cavities with the viscous material such that the viscous material begins to flow into a second surface cavity after a first surface cavity is at least partially filled.

In some embodiments, the material outlet 176 may be in fluid communication with adjacent surface cavities at least partially concurrently. For example, although the material outlet 176 may be in fluid communication with the surface cavity 161 before the surface cavity 162, the material outlet 176 may be in fluid communication with each of the surface cavities 161, 162 at least partially concurrently. In FIG. 4, the surface cavity 161 is completely (or almost completely) filled, but the surface cavity 162 is only partially filled. Accordingly, in some embodiments, the cavity openings 180 of the surface cavities 161-164 may be dimensioned and located proximate to each other and the material outlet 176 may be dimensioned relative to the surface cavities 161-164 such that the material outlet 176 is simultaneously in fluid communication with two surface cavities.

However, in other embodiments that include a series of surface cavities, the gas inlet 174 and/or the material outlet 176 may be configured to be in fluid communication with only one surface cavity at a time. For example, a first surface cavity may be evacuated and sealed before a second adjacent surface cavity begins evacuation. Likewise, in other embodiments, a first surface cavity may be filled by the designated amount of viscous material before the viscous material begins flowing into a second adjacent surface cavity. By way of example, the material outlet 176 may be in fluid communication with the surface cavity 161 and, when the material outlet 176 is no longer in fluid communication with the surface cavity 161, the material outlet 176 becomes in fluid communication with the surface cavity 162.

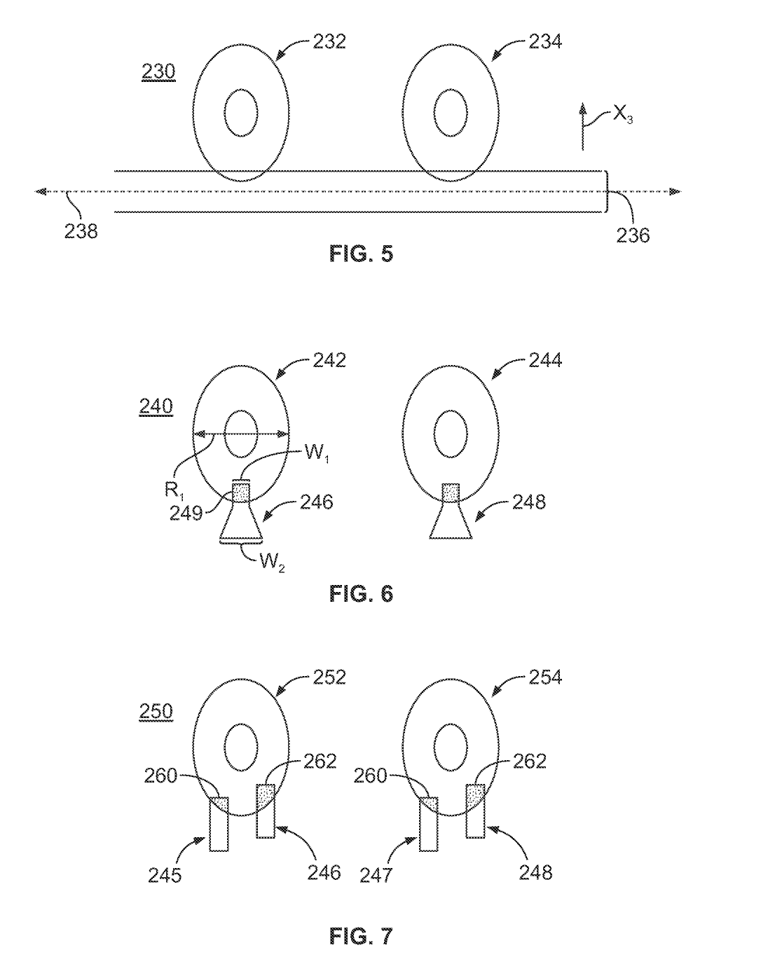

FIGS. 5-7 illustrate different configurations of material outlets that may be used with embodiments described herein. FIG. 5 shows an exterior surface 230 having cavity openings 232 and 234 and also shows a material outlet 236 as the material outlet 236 slides over the cavity openings 232, 234 while moving in a direction indicated by the arrow X₃. As shown, the material outlet 236 may be an elongated channel that extends lengthwise along a channel axis 238. The material outlet 236 is dimensioned (e.g., sized and shaped) such that each of the cavity openings 232, 234 is simultaneously in fluid communication with the material outlet 236 at some time. Thus, in some embodiments, the viscous material (not shown) may flow through the single outlet 236 at least partially concurrently into the multiple cavity openings 232, 234.

In certain embodiments, the cavity openings and the material outlets may be configured relative to each other such that the viscous material flows into the corresponding surface cavities through localized portions of the cavity opening and/or at designated moments in time. By controlling the location(s) and times at which the viscous material flows through a cavity opening, the flow and distribution of the viscous material in the corresponding surface cavity may be controlled. For example, the flow and distribution of the viscous material may be controlled to direct bubble formation and location in the surface cavity.

For example, FIG. 6 shows an exterior surface 240 having cavity openings 242 and 244 and material outlets 246 and 248. The material outlets 246, 248 have a leading width W₁ and the cavity openings 242, 244 have a diameter R₁. The leading width W₁ is less than the diameter R₁. Accordingly, the viscous material (not shown) may initially flow through a localized portion 249 of the corresponding cavity opening. Also shown in FIG. 6, each of the material outlets 246, 248 may have a common trailing width W₂ that is greater than the leading width W₁. As the material outlets 246, 248 slide over the respective cavity openings 242, 244, the localized portions 249 may increase in size thereby changing the flow and distribution of the viscous material into the corresponding surface cavity.

FIG. 7 shows an exterior surface 250 having cavity openings 252 and 254 and outlets 245-248. In the illustrated embodiment, the material outlets 245, 246 slide over the cavity opening 252, and the material outlets 247, 248 slide over the cavity opening 254. As shown, the material outlets 245, 246 are located relative to one another such that the material outlets 245, 246 clear the cavity opening 252 at different times. Likewise, the material outlets 247, 248 are located relative to one another such that the material outlets 247, 248 clear the cavity opening 254 at different times Each pair of material outlets 245, 246 and 247, 248 form respective localized portions 260, 262 when the material outlets clear the cavity opening. The viscous material may flow at least partially concurrently, including simultaneously, through the localized portions 260, 262 into the corresponding surface cavity. Accordingly, a plurality of outlets may be used to deposit viscous material into a single surface cavity, and the outlets may be arranged with respect to each other to control the flow and distribution of the viscous material.

Returning to FIG. 3, the method 120 may also include curing at 130 the viscous material 178 in the surface cavity. Curing may be performed, for example, by heating the viscous material 178, subjecting the viscous material 178 to UV radiation or chemical additives, or allowing the viscous material 178 to dry and harden under ambient conditions. Optionally, the method 120 may also include forming at 132 a planar electronic device using the board substrate, such as the planar electronic device 270 described below.

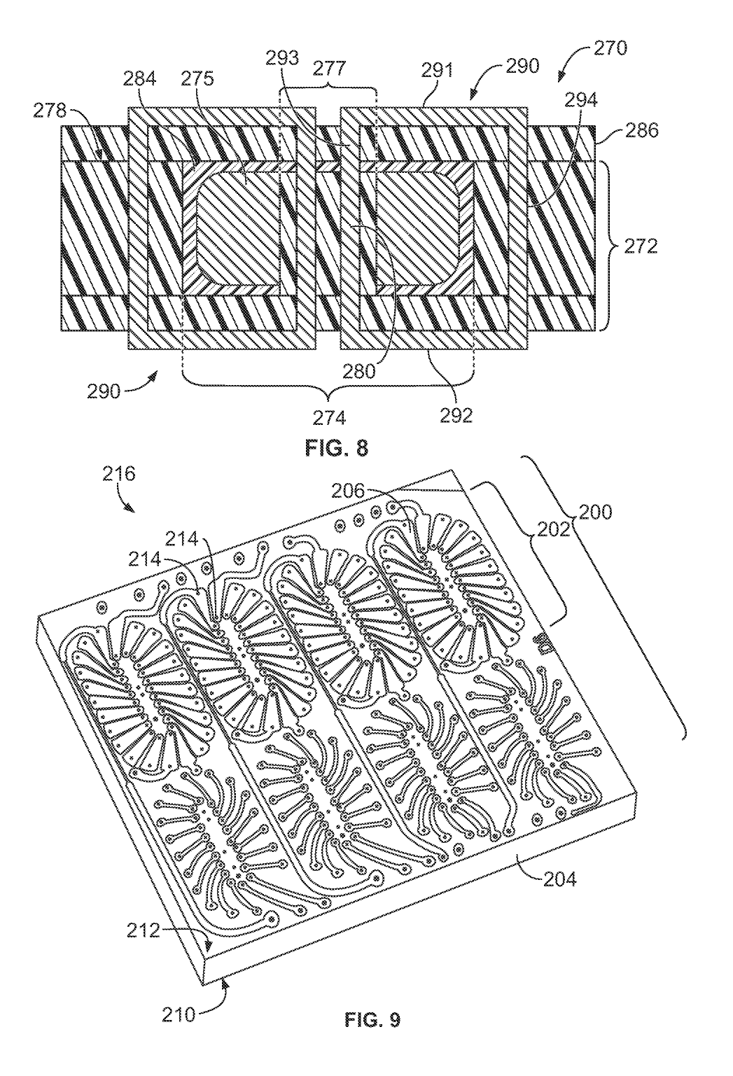

FIG. 8 shows a cross-section of a portion of a planar electronic device 270 that includes a board substrate 272. The board substrate 272 includes an exterior surface 278. The board substrate 272 may be similar to the board substrate 150 (FIG. 4) described above. As shown, a magnetic core 275 (or other electrical functional component) may be disposed in a surface cavity 274 of the board substrate 272. The magnetic core 275 may be positioned in the surface cavity 274 before or after a viscous material 284 is deposited in the surface cavity 274. The magnetic core 275 may have a circular or oval-like shape that surrounds a core void 277. The magnetic core 275 is inserted into the surface cavity 274 through the side of the board substrate 272 having the exterior surface 278. A dielectric member 280 of the board substrate 272 may be disposed in the core void 277 after the magnetic core 275 is inserted.

The viscous material 284 may be an elastic and non-conductive encapsulating material. The viscous material 284 may flow into the surface cavity 274, including the core void 277, and envelope the magnetic core 275. The viscous material 284 may be cured as described above such that the viscous material 284 is hardened and completely surrounds the magnetic core 275.

A substrate layer 286 may be stacked onto the exterior surface 278 to enclose the surface cavity 274 with the cured viscous material 284 and the magnetic core 275 therein. In some embodiments, conductive windings 290 may then be formed with respect to the magnetic core 275. For example, the conductive windings 290 may extend through the core void 277 and wrap around the magnetic core 275 a plurality of times. As shown in FIG. 8, the conductive windings 290 may include trace portions 291, 292 that extend along sides of the electronic device 270 and thru-hole portions 293, 294 that may extend through the board substrate 272, including the cured viscous material 284.

FIG. 9 is a perspective view of one embodiment of a planar electronic device 216 having an array 200 of magnetic devices 202. The electronic device 216 may be manufactured in a similar manner as described above with respect to FIGS. 1-8. The magnetic devices 202 shown in FIG. 9 are transformer devices. Alternatively, the magnetic devices 202 may be or include another device or component, such as an inductor, filter, balun, coupler, and the like. The magnetic device 202 may include a magnetic core, such as a ferrite body or other magnetic material. As shown, the magnetic devices 202 are disposed in a planar dielectric or non-conductive board substrate 204. The illustrated magnetic devices 202 are generally oval-shaped, but may have different shapes, such as a circular shape.

For each magnetic device 202, several top conductors 206 are disposed on an upper side 212 of the board substrate 204 and several bottom conductors (not shown) are disposed on a lower side 210 of the board substrate 204. The bottom conductors may be the same size and/or shape as the top conductors 206. The board substrate 204 includes vias 214 that extend through the board substrate 204 between the lower and upper sides 210, 212 of the board substrate 204. The vias 214 are filled or plated with a conductive material to provide conductive pathways through the board substrate 204. Opposite ends of each via 214 are conductively coupled with the top conductors 206 and the bottom conductors on the board substrate 204. The vias 214, the top conductors 206, and the bottom conductors may form conductive pathways or windings, like the conductive windings 290 (FIG. 8), that wrap multiple times around the magnetic core disposed within the board substrate 204.

As used herein, an element, step, or operation recited in the singular and proceeded with the word “a” or “an” should be understood as not excluding plural of said elements, steps, or operations unless such exclusion is explicitly stated. Furthermore, references to “one embodiment” are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the inventive subject matter without departing from its scope. Dimensions, types of materials, orientations of the various components, and the number and positions of the various components described herein are intended to define parameters of certain embodiments, and are by no means limiting and are merely exemplary embodiments. Many other embodiments and modifications within the spirit and scope of the claims will be apparent to those of skill in the art upon reviewing the above description. The scope of the inventive subject matter should, therefore, be determined with reference to the appended claims, along with the full scope of equivalents to which such claims are entitled, in the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means plus-function format and are not intended to be interpreted based on 35 U.S.C. §112, sixth paragraph, unless and until such claim limitations expressly use the phrase “means for” followed by a statement of function void of further structure.

What is claimed is:

1. A method of depositing a viscous material into a surface cavity of a target object, the method comprising:
providing the target object having the surface cavity, the target object including an exterior surface having a cavity opening that provides access to the surface cavity;
evacuating air from the surface cavity through the cavity opening;
covering the cavity opening to seal the surface cavity, the surface cavity holding a partial vacuum when the surface cavity is sealed; and
permitting a viscous material to flow into the surface cavity through the cavity opening as the cavity opening is uncovered.

2. The method of claim 1, wherein the target object includes a plurality of the surface cavities having corresponding cavity openings, the viscous material flowing, into the plurality of the surface cavities at least partially concurrently.

3. The method of claim 1, wherein the surface cavity is a blind cavity.

4. The method of claim 1, wherein the viscous material is a resin, mixture, or slurry, the method further comprising curing the viscous material.

5. The method of claim 1, wherein the target object includes a hoard substrate, the method further comprising forming an electronic device that includes the board substrate.

6. The method of claim 1, wherein the viscous material is held in a reservoir before flowing into the surface cavity, the reservoir being in fluid communication with a port to ambient air, wherein the permitting operation includes permitting air to flow through the port into the reservoir as the viscous material exits the reservoir.

7. The method of claim 1, further comprising loading a device component into the surface cavity, the viscous material at least partially surrounding the device component in the surface cavity.

8. The method of claim 1, wherein the target object is a board substrate, the method further comprising stacking a substrate layer onto the exterior surface thereby enclosing the surface cavity.

9. The method of claim 1, wherein the permitting operation includes permitting the viscous material to simultaneously flow through at least two separate portions of the cavity opening into the surface cavity.

10. The method of claim 1, wherein the permitting operation includes permitting the viscous material to flow from a reservoir through a material outlet and into the surface cavity, the reservoir moving relatively alongside the exterior surface.

11. A method of depositing a viscous material into a target object, the method comprising:
providing the target object, the target object including first and second surface cavities;
evacuating air from the first and second surface cavities;
sealing the first and second surface cavities, the surface cavities holding partial vacuums when sealed; and
sequentially filling the first and second surface cavities with the viscous material such that the viscous material begins to flow into the second surface cavity after the first surface cavity is at least partially filled.

12. The method of claim 11, wherein the method includes sequentially sealing the first and second surface cavities such that the first surface cavity is sealed before the second surface cavity is sealed.

13. The method of claim 11, wherein the first and second surface cavities are filled by a filling device, the filling device having a material outlet that the viscous material flows through, the material outlet sliding over an exterior surface of the target object that includes the first and second surface cavities, wherein the material outlet is dimensioned to permit the viscous material to flow into the first and second surface cavities at least partially concurrently.

14. The method of claim 11, wherein the first and second surface cavities are filled by a filling device, the filling device having a material outlet that the viscous material flows through, the material outlet configured to slide along an exterior surface of the target object that includes the first and second surface cavities, wherein the first and second cavities are aligned with each other such that the material outlet is in fluid communication with the first surface cavity before the second surface cavity when the material outlet slides along the exterior surface.

15. A system comprising:
a system housing having an engagement side configured to form an interface with an exterior surface of a target object, the exterior surface having a cavity opening that provides access to a surface cavity of the target object, the engagement side including a gas inlet and a material outlet that are configured be in fluid communication with the surface cavity at different times as the engagement side slides along the target object;
a vacuum device having a flow chamber that is in fluid communication with the gas inlet, the vacuum device generating a suction airflow through the gas inlet and into the flow chamber to evacuate the surface cavity, the engagement side covering the cavity opening after the surface cavity is evacuated such that a partial vacuum exists therein; and
a filling device having a reservoir for holding a viscous material, the reservoir being in fluid communication with the material outlet, the viscous material flowing through the material outlet and into the surface cavity when the material outlet clears the cavity opening.

16. The system of claim 15, further comprising an object holder configured to position the target object against the engagement side.

17. The system of claim 15, wherein the filling device fills a plurality of the surface cavities at least partially concurrently.

18. The system of claim 15, wherein the engagement side is pressed against the exterior surface of the target object to impede fluid leakage along the interface.

19. The system of claim 15, wherein the vacuum device includes an airflow generator, at least one of the reservoir or the airflow generator moving with the engagement side as the engagement side slides along the exterior surface.

20. The system of claim 15, wherein the material outlet is dimensioned to be in fluid communication with a plurality of the surface cavities at least partially concurrently, the viscous material flowing through the material outlet into each of the surface cavities.
